(19) United States
(12) Patent Application Publication
(10) Pub. No.: US 2003/0023403 A1
(43) Pub. Date: Jan. 30, 2003

(54) Process for estimating random error in chemical and biological assays when random error differs across assays

(76) Inventors: Robert Nadon, Baie d' Urte (CA); Peide Shi, North York (CA); Peter Ramm, St Catherines (CA)

Correspondence Address: Joseph B Lerch, Darby & Darby, Post Office Box 5257, New York, NY, 10150-5257, US

(21) Appl. No.: 10/220,661

(22) PCT Filed: Mar. 2, 2001
(86) PCT No.: PCT/IB01/00297

(51) Int. Cl. G06F 101/14

(52) U.S. Cl. 702/179

(57) ABSTRACT

An analytical process is disclosed, for discriminating data acquired from samples with overlapping distributions, and for improving and assessing the statistical validity of hybridization signal in arrays of assays. The process includes method of convolving data into two or more discrete probability density functions representing signal and nonsignal, discrete fluors, or other convolved independent variables. The system uses the probability density functions to assign hybridization signals, objectively, to one of the modeled distributions. Subsequent processes assess variability inherent to the arrays, and use this assessed variation to establish reliability scores and confidence limits for complete hybridization arrays, and for discrete hybridization assays within arrays.

### FIELD OF THE INVENTION

The present invention relates to a process for making evaluations which objectify analyses of data obtained from hybridization arrays. The present invention is a process for estimating the random error present in replicate genomic samples composed of small numbers of data points when this random error differs across the samples.

### BACKGROUND OF THE INVENTION

Array-based genetic analyses start with a large library of cDNAs or oligonucleotides (probes), immobilized on a substrate. The probes are hybridized with a single labeled sequence, or a labeled complex mixture derived from a tissue or cell line messenger RNA (target). As used herein, the term “probe” will therefore be understood to refer to material tethered to the array, and the term “target” will refer to material that is applied to the probes on the array, so that hybridization may occur.

The term “element” will refer to a spot on an array. Array elements reflect probe/target interactions.

The term “treatment condition” will refer to an effect of interest. Such an effect may pre-exist (e.g., differences across different tissues or across time) or may be induced by an experimental manipulation.

The term “replicates” will refer to two or more measured values of the same probe/target interaction. These values may be statistically independent across two or more different treatment conditions (in which case the random measurement error is estimated separately for each condition) or they may be statistically dependent across conditions (in which case the random measurement error is estimated taking the dependence into account). Replicates may be within arrays, across arrays, within experiments, across experiments, or any combination thereof.

Measured values of probe/target interactions are a function of their true values and of measurement error. The term “outlier” will refer to an extreme value in a distribution of values. Outlier data often result from uncorrectable measurement errors and are typically deleted from further statistical analysis.

Chen, Dougherty, & Bittner “Ratio-based decisions and the quantitative analysis of cDNA microarray images”,

Journal of Biomedical Optics, 2, 364-374 (1997) have presented an analytical mathematical approach that estimates the distribution of non-replicated differential ratios under the null hypothesis. This approach is similar to the present invention in that it derives a method for obtaining confidence intervals and probability estimates for differences in probe intensities across different conditions. It differs from the present invention in how it obtains these estimates. Unlike the present invention, the Chen et al. approach does not obtain measurement error estimates from replicate probe values. Instead, the measurement error associated with ratios of probe intensities between conditions is obtained via mathematical derivation of the null hypothesis distribution of ratios. That is, Chen et al. derive what the distribution of ratios would be if none of the probes showed differences in measured values across conditions that were greater than would be expected by “chance.” Based on this derivation, they establish thresholds for statistically reliable ratios of probe intensities across two conditions. The method, as derived, is applicable to assessing differences across two conditions only. Moreover, it assumes that the measurement error associated with probe intensities is normally distributed. The method, as derived, cannot accommodate other measurement error models (e.g., lognormal). It also assumes that all measured values are unbiased and reliable estimates of the “true” probe intensity. That is, it is assumed that none of the probe intensities are “outlier” values that should be excluded from analysis. Indeed, outlier detection is not possible with the approach described by Chen et al.

The present invention extends the processes described by Ramm and Nadon in “Process for Evaluating Chemical and Biological Assays” (International Publication No. WO 90/54724) and by Ramm, Nadon and Shi in “Process for Estimating Random Error in Statistically Dependent Chemical and Biological Assays” (International Publication No. WO 00/78991). These patent applications describe processes for estimating random error in chemical and biological assays when the assays share a common “true” random error. The present invention differs in that it estimates random error in chemical and biological assays when the assays do not share a “true” random error.

The present invention differs from prior art in that:

1. It can accommodate various measurement error models (e.g., lognormal);

2. It can detect outliers within the context of a statistical model;

3. It can be used to examine theoretical assumptions about data structure (e.g., that residuals are normally distributed);

4. It can estimate random error when assays do not share a common underlying “true” random error distribution.

### BRIEF DESCRIPTION OF THE DRAWINGS

Further objects, features and advantages of the invention will be understood more completely from the following detailed description of a presently preferred, but nonetheless illustrative embodiment, with reference being had to the accompanying drawings, in which:

FIGS. 1 and 2 are flow charts illustrating preferred embodiments of the process;

FIG. 3 is a graphical representation of data which accord with Equation 1; and

FIG. 4 is a graphical representation of data which accord with Equation 2.

### DETAILED DESCRIPTION OF THE PREFERRED EMBODIMENT

Suppose, for example, that expression levels for a particular data set have additive systematic and additive random error across replicate arrays (either on a raw scale or after an appropriate transformation of the raw data, e.g., log). This scenario is represented symbolically in Equation 1:

y_{gij}=μ_{gi}+v_{gi}+σ_{g}ε_{gij} (1)

for g=1, . . . ,G, j=1, . . . ,m and i=1, . . . ,n, where μ_{gi} represents the associated true intensity value of array element i (which is unknown and fixed) (or of dependent array element pair i), v_{gj} represents the unknown systematic shifts or offsets across replicates, ε_{gij} represents a standardized random variable [˜N (0,1)] in a given condition g for spot i and replicate j, σ_{g} represents the variation of the unknown random error, δ_{g} is an unknown parameter for g=1,. . . ,G, and we have \hat{σ}_{g}²−σ_{g}²=Oₚ(n^{-1/2}), \sqrt{n}\hat{σ}_{g}²−σ_{g}²˜N(0,δ_{g}) (where \hat{σ}_{g}² is an estimate of σ_{g}². The interest lies in obtaining an unbiased estimate of the “true” value (μ_{gi}).

Given condition g (e.g., normal cells or diseased counterparts), array element i, and replicate j, the associated intensity value is denoted as y_{gij}.

To make the parameter v_{gj} identifiable in the model, the restriction that

$${\sum }_{j = 1}^{m} {v}_{g i} = 0$$

is required.

This parameter can be taken to be fixed or random. When the parameter is assumed to be random, we assume further that it is independent of the random errors.

The model shown in Equation 1 will be presented as a preferred embodiment of the special case where the unknown random error is the same for all spots within a given condition in the case of statistically independent conditions (or is the same for all differences between corresponding spots across conditions in the case of statistically dependent conditions). This process has been described by Ramm and Nadon in “Process for Evaluating Chemical and Biological Assays” (International Publication No. WO 90/54724) and by Ramm, Nadon and Shi in “Process for Estimating Random Error in Statistically Dependent Chemical and Biological Assays” (International Publication No. WO 00/78991). Applications of the process using other models (e.g., proportional offset and additive random error), however, would be obvious to one skilled in the art.

Equation 2 represents the general case where the unknown random error is not the same for all spots within a given condition in the case of statistically independent conditions (or is not the same for all differences between corresponding spots across conditions in the case of statistically dependent conditions). In the preferred embodiment of the general case scenario, the unknown random error is related to the true intensity value of array element i (or of dependent array element pair i).

y_{gij}=μ_{gi}+v_{gi}+σ_{gi}ε_{gij} (2)

where terms are defined as for Equation 1. We have max, |\hat{σ}_{gi}²−σ_{gi}²|=Oₚ(n_{-r/(2r+1)}) where \hat{σ}_{gi}² is an estimate of σ_{gi}² (e.g., regression quantile estimate) and r is the smoothness of the unknown variance function (whereby the standard deviation of the replicates, or by some other measure of replicate variability, is predicted on the basis of the mean of the replicates, or by some other measure of replicate central tendency). Other scenarios are possible. The standard deviation (or other measure of replicate variability) across replicates may be predicted based on other measures [e.g., array spot quality, sequence length, molecule content (DNA, RNA, or protein), hybridization conditions, experimental conditions, array background, normalization references]. Multiple predictors could also be combined in various ways (e.g., linear, non-linear, factorial) in a manner that would be obvious to one skilled in the art.

In Equation 2, the difference between \hat{σ}_{gi}² (the estimated population variance across replicates for spot i) and σ_{gi}² (the true population variance across replicates for spot i) tends to zero as n (the number of spots) goes to infinity. Therein lies the key novelty. As with the special case described by Ramm and Nadon in “Process for Evaluating Chemical and Biological Assays” (International Publication No. WO 90/54724) and by Ramm, Nadon and Shi in “Process for Estimating Random Error in Statistically Dependent Chemical and Biological Assays” (International Publication No. WO 00/78991), the relatively large numbers of replicates typically required to obtain precise estimates of random error are not necessary in the present invention. All that is required is a relatively large number of spots which can have as few as two replicates each.

The present invention does not preclude the use of prior art normalization procedures being applied to the data before application of the present process. This may be necessary, for example, when data have been obtained across different conditions and different days. Under this circumstance, data within conditions may need to be normalized to a reference (e.g., housekeeping genes) in conjunction with applying the present process.

### Example of The Process Measurement Error Model Known

In one preferred aspect, the present invention assumes that systematic error has been minimized or modeled by application of known procedures (e.g., background correction, normalization) as required. In another preferred aspect, the present invention could be used with systematic error that has been modeled and thereby removed as a biasing effect upon discrete data points. The process could also be used with unmodeled data containing systematic error, but the results would be less valid.

To facilitate exposition, the following discussion assumes that probes are replicated across arrays. The process applies, equally, however, to cases in which replicates are present within arrays or some combination of the two.

Two common error models are “additive” and “proportional.” An error model with constant variance, regardless of measured quantity, is called an “additive model.”An error model with variance proportional to the measured quantity is called a “proportional model.” This latter model violates the assumption of constant variance assumed by many statistical tests. In this case, a logarithm transformation (to any convenient base) changes the error model from proportional to additive. In the process here discussed, a logarithm transformation may be applied to each individual array element. Other transformations or no transformation are envisaged, depending on the error model.

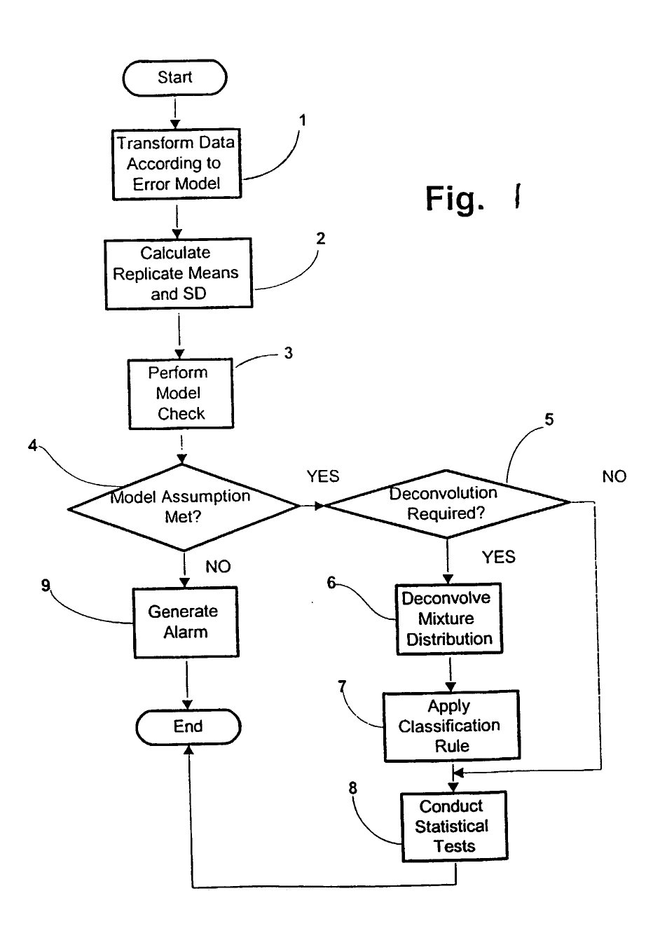

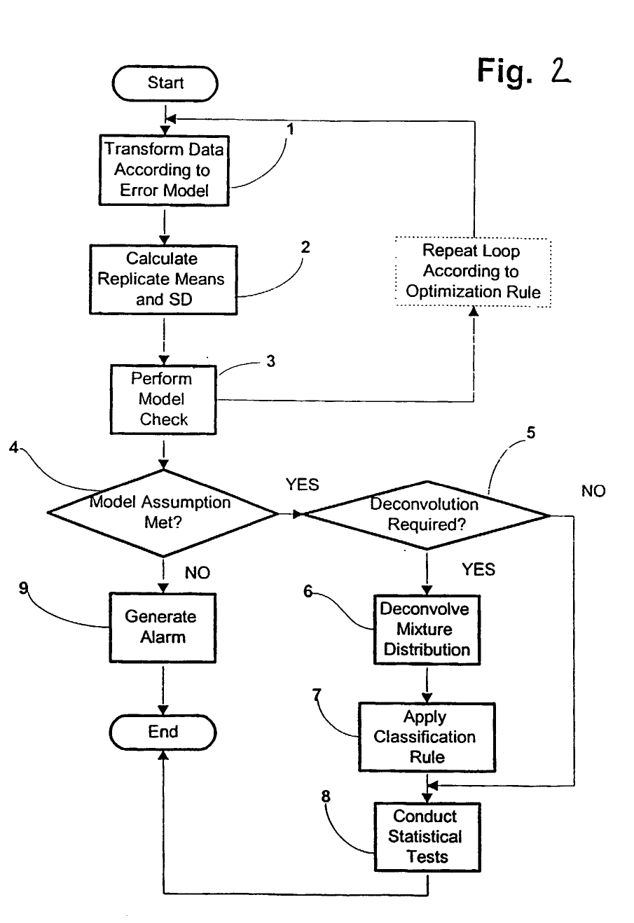

FIGS. 1 and 2 are flow charts illustrating preferred embodiments of the process. Other sequences of action are envisioned. For example, blocks 5 through 7, which involve the deconvolution and classification procedures, might be inserted between blocks 2 and 3. That is, in this alternate embodiment, deconvolution would precede replicate measurement error estimation.

An overview of the process when the measurement error model is known is shown in FIG. 1. The paragraphs below are numbered to correspond to the functional block numbers in the figure.

1. Transform Data According to Error Model

In block 1, the raw data are transformed, if necessary, so that assumptions required for subsequent statistical tests are met.

2. Calculate Replicate Means and Standard Deviations

Each set of probe replicates is quantified (e.g., by reading fluorescent intensity of a replicate cDNA) and probe values are averaged to generate a mean for each set. An unbiased estimate of variance is calculated for each replicate probe set, as are any other relevant descriptive statistics.

3. Perform Model Check

In a key aspect of the present invention, average variability for each set of replicates is predicted by nonparametric regression procedures (or other predictive functions) in which the observed variability is regressed on averaged signal intensity (or other predictor or predictors). This statistic can then be used in diagnostic tests. Various error models and diagnostic tests are possible. Diagnostic tests include graphical (e.g., quantile-quantile plots to check for distribution of residuals assumptions) and formal statistical tests (e.g., chi-squared test; Kolmogorov-Smirnov test; tests comparing mean, skewness, and kurtosis of observed residuals relative to expected values under the error model). If the assumptions of the error model are satisfied, thresholds can be established for the removal of outlier residual observations (e.g., ±3 standard deviations away from the mean). The assumptions of the model can be re-examined with the outliers removed and the average variability for each replicate set can be recalculated. This variability measure can then be used in block 8.

4. Model Assumptions Met?

In block 4, a judgement is made as to whether the distribution of residuals is adequate to proceed with the data analysis. If yes, we proceed to block 5. If no, we proceed to block 9.

5. Deconvolution Required?

In block 5, a decision is made as to whether deconvolution of a mixture distribution of values may be required. If required, we proceed to block 6. If not required, proceed to block 8.

6. Deconvolve Mixture Distribution

In a key aspect of the present invention, the input data for this process are the element intensities taken across single observations or (preferably) across replicates. In a preferred aspect, the E-M algorithm and any modifications which make its application more flexible (e.g., to allow the modeling of normormal distributions; to allow the use of a priori information, e.g., negative values are nonsignal) provides a convenient algorithm for modeling underlying distributions. Other approaches to mixture deconvolution are possible.

7. Apply Classification Rule

Given the parameters of the distribution obtained in block 6, it will be of interest to classify observations as falling into one class or another (e.g., signal and nonsignal). Observations may be classified according to the procedure described in the section entitled “Use the probability density function to assign hybridization values to their distribution of origin.”

8. Statistical Tests

Once measurement error has been determined, standard statistical tests are conducted and confidence intervals are provided. Such tests would include dependent and independent t-tests and dependent and independent analyses of variance (ANOVA) and other standard tests. These comparisons would be made between replicate means from different conditions. Other tests are possible. Upon completion of the tests, the process ends. This is considered to be a normal termination.

9. Generate Alarm

If error model assumptions are not met, an alarm is generated, and the process ends. This is considered to be an abnormal termination. Three solutions are then possible. Raw data may be transformed manually by the Box-Cox or other procedures. The process could be started anew, so that the assumptions of a new model may be assessed. Alternatively, the optimization strategy shown in FIG. 2 could be applied. Finally, the error distribution could be estimated by empirical non-parametric methods such as the bootstrap or other procedures.

Measurement Error Model Not Known

When the measurement error model is unknown, the process, as represented in FIG. 2. is identical to the one used when the error model is known except in how the error model is chosen. In this instance, the error model is chosen based on a computer intensive optimization procedure. Data undergo numerous successive transformations in a loop from blocks 1 through 3. These transformations can be based, for example, on a Box-Cox or other type of transformation obvious to one skilled in the art. The optimal transformation is chosen based on the error model assumptions. If the optimal transformation is close to an accepted theoretically-based one (e.g., log transform), the latter may be preferred. The process proceeds through the remaining steps in the same manner as when the error model is known.

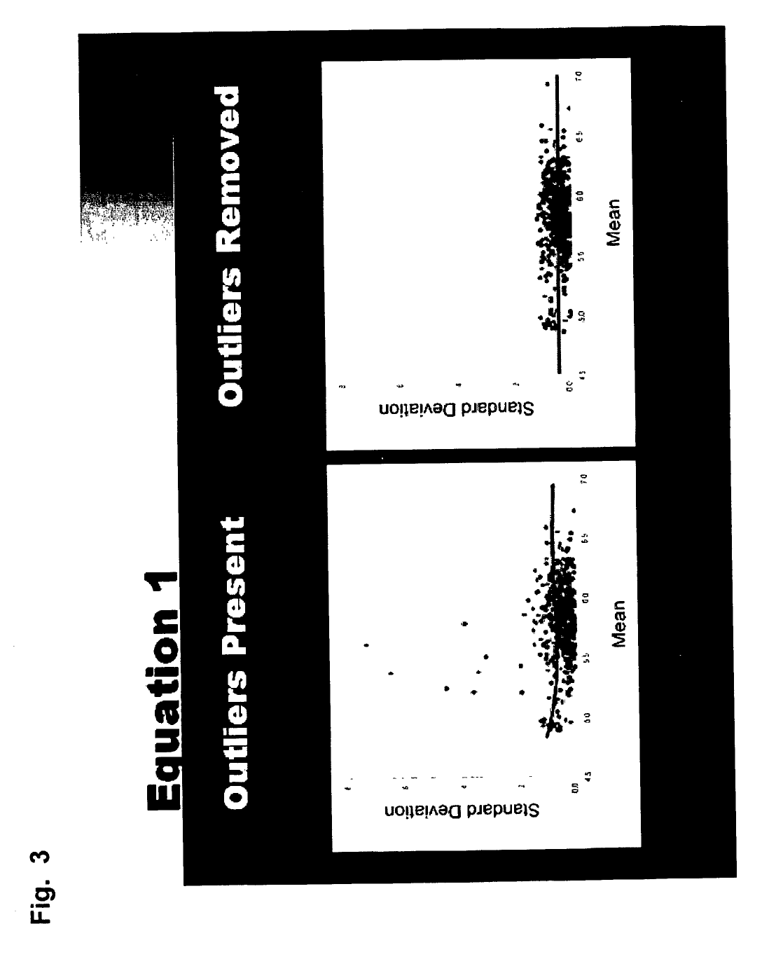

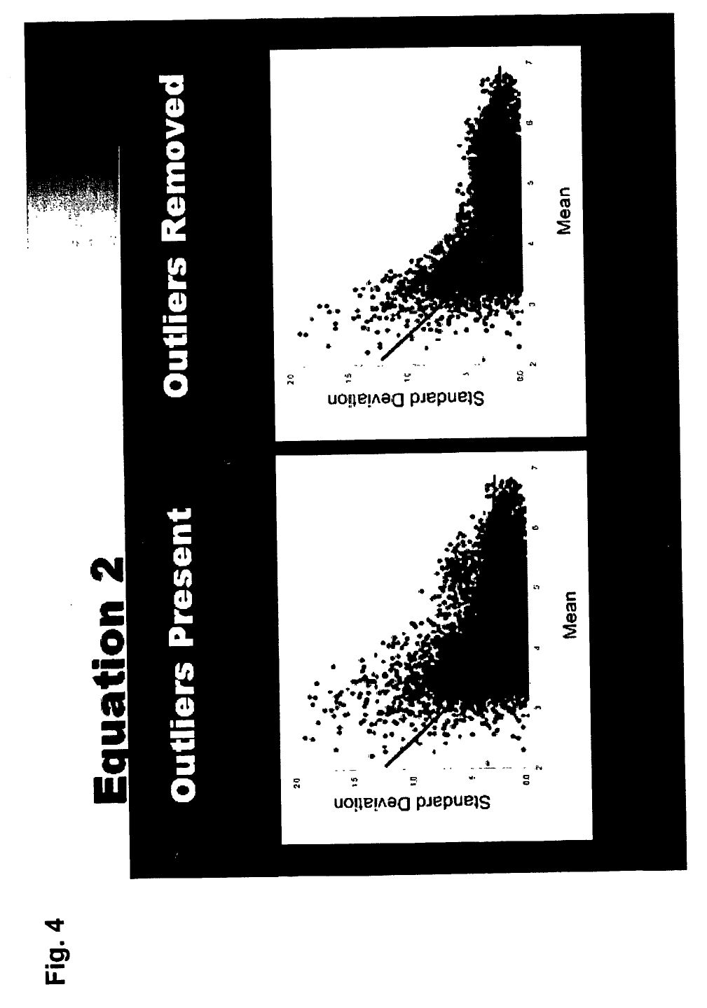

FIG. 3 is a graphical representation of data which accord with Equation 1 and FIG. 4 is a graphical representation of data which accord with Equation 2.

### Conclusion

Once the estimates of random measurement error across replicates have been obtained, the processes described by Ramm and Nadon in “Process for Evaluating Chemical and Biological Assays” (International Publication No. WO 90/54724) and by Ramm, Nadon and Shi in “Process for Estimating Random Error in Statistically Dependent Chemical and Biological Assays” (International Publication No. WO 00/78991), or other processes requiring random measurement error estimates can be applied.

Although a preferred embodiment of the invention has been disclosed for illustrative purposes, those skilled in the art will appreciate that many additions, modifications and substitutions are possible without departing from the scope and spirit of the invention.

What is claimed is:

1. A method for improving the reliability of physical measurements obtained from array hybridization studies performed
on an array having a large number of genomic samples, each composed of a small number of replicates insufficient for making
precise and valid statistical inferences, comprising the step of
estimating an error in measurement of a sample by predicting error estimates on the basis of a measure of replicate central tendency, and utilizing the estimated sample error as a standard for accepting or rejecting the measurement of the respective sample.

2. The method of claim 1 wherein the measure of central tendency is one of: (i) the mean of the replicates and (ii) a single predictor, multiple predictors or a combination thereof.

3. The method of claim 1 wherein a physical measurement quantity determined from an entire array population is used to estimate discrete instances of that quantity for the small number of replicate samples within that population.

4. The method of claim 1, 2 or 3 wherein the estimates of measurement error are used to plan, manage and control array hybridization studied on the basis of (a) the probability of detecting a true difference of specified magnitude between physical measurements; of a given number of replicates, or (b) the number of replicates; required to detect a true difference of specified magnitude.

5. A method in which outliers are identified using error estimates arrived at as in claims 1, 2 or 3.

6. The method of any one of claims 1, 2 or 3 used for data obtained from biological and chemical assays conducted in one of well plates, test tubes and other media.

9. The method of claim 4 used to make valid inferences regarding data obtained from biological and chemical assays conducted in one of well plates, test tubes and other media.

10. The method of claim 5 used to make valid inferences regarding data obtained from biological and chemical assays conducted in one of well plates, test tubes and other media.
